(19) United States
(12) Patent Application Publication
(10) Pub. No.: US 2005/0129017 A1
(43) Pub. Date: Jun. 16, 2005

(54) Multicast flow accounting

(75) Inventors: Pierrick Guingo, Ottawa (CA); Jerome Cornet, Ottawa (CA); Arnold Jansen, Manotick (CA); Fernando Cuervo, Ottawa (CA)

Correspondence Address: KRAMER & AMADO, P.C., 2001 JEFFERSON DAVIS HWY, SUITE 1101, ARLINGTON, VA, 22202, US

(73) Assignee: Alcatel, Paris (FR)

(21) Appl. No.: 10/732,529

(22) Filed: Dec. 11, 2003

(51) Int. Cl. H04L 12/56

(52) U.S. Cl. 370/390

(57) ABSTRACT

A methods of implementing event based distributed multicast flow accounting are presented. Multicast-enabled routers request, and aggregate traffic flow measurement information from downstream multicast-enabled routers participating in dependent multicast sub-trees. Records are kept by the multicast-enabled router regarding changes to the underlying multicast tree topology. The aggregate traffic flow measurements and topology information are reported to multicast-enabled routers upstream. Advantages are derived from the ability to accurately compute multicast content transport costs within a communications service provider's network.

### FIELD OF THE INVENTION

The invention relates to communications, and in particular to providing flow accounting in support of multicast and broadcast service provisioning.

### BACKGROUND OF THE INVENTION

In the field of packet-switched communications, broadcast content transport using multicast techniques provides opportunities for delivery of continuous multimedia streams such as, but not limited to: audio (e.g. net radio services), video (e.g. web conferencing), data (e.g. ticker tape), etc., from a source communications network node broadcasting content to a group of receivers such as multiple destination communications network nodes, far more effectively than currently employed unicast technologies.

While broadcast content transport using multicast techniques is a promising developing technology for dissemination of multimedia content across a communication network, there is a need for further development in the area of per-usage accounting.

Multicast transport protocols have been under research and employed in broadcasting content across communication networks for some years now, however satisfactory and effective methods for multicast flow accounting are still being sought to measure resource utilization.

Current proposals have centered on billing models: sender-based versus receiver-based; and on pricing models: flat-rate versus usage-based, rather than on a technology enabling multicast flow accounting.

Content multicasting via packet-switched communications networks enables the transmission of a single packet from a source to multiple destinations by replicating the packet at multicast-enabled routers in the communications network until copies of the packet reach all destinations. Broadcast content subscribers, at the multiple destinations, register into specific multicast groups and request content. In registering a new broadcast content subscriber into a specific multicast group, an upstream multicast-enabled router conveying the broadcast content sought, adds the network address of the broadcast content subscriber's destination to a corresponding multicast group list managed by the multicast enabled router. This makes it difficult to evaluate the cost of transport of a multicast packet across the communications network and to set up a sender-based billing because none of the multicast-enabled routers upstream from the multicast-enabled router which performed the registration are aware of all downstream distribution paths of the multicast flow which may change as subscribers dynamically join and leave multicast groups.

Currently there is no prior art solution that effectively addresses these issues.

Per flow resource utilization measurement methods have been actively developed providing fine grained measurement of unicast traffic conveyed in a communications network, but no multicast-specific application has been created using this technology.

There therefore is a need to solve the above mentioned issues.

### SUMMARY OF THE INVENTION

In accordance with an aspect of the invention, a method of deriving resource utilization information regarding a multicast flow at a multicast-enabled router participating in a multicast tree is provided. The method is initiated upon the detection of a triggering event. Topology information regarding downstream dependent sub-tree portions of the multicast tree is aggregated at the router. Traffic flow measurements regarding content is conveyed in the dependent sub-tree portions of the multicast tree downstream of the router. Lastly, the aggregated topology and traffic flow measurement information is reported upstream along the multicast tree.

In accordance with another aspect of the invention, the method includes correlating the topology information to the traffic flow measurement information.

In accordance with a further aspect of the invention, a resource utilization update request is forwarded in respect of each triggering event via interfaces associated with dependent sub-tree portions.

In accordance with a further aspect of the invention, resource utilization reports are received via interfaces corresponding to dependent sub-tree portions.

In accordance with a further aspect of the invention, topology information and traffic flow measurement information is stored in storage associated with the router along with a time stamp enabling historical tracking of resource utilization information.

In accordance with a further aspect of the invention, the method includes determining that multicast flow content is being forwarded via a local access link associated with a destination content consumer node. The router asserts itself as an egress router in respect of an interface corresponding to the local access link. And, obtains traffic flow measurements in respect of content conveyed via the interface.

In accordance with a further aspect of the invention, obtaining traffic flow measurements is performed in response to a triggering event.

In accordance with a further aspect of the invention, a time stamp is associated with each traffic flow measurement.

In accordance with a further aspect of the invention, should the router determine that multicast flow content is being received via a local access link associated with a source broadcast content provider node, the router asserts itself as an ingress router in respect of an interface corresponding to the local access link.

In accordance with a further aspect of the invention, in reporting the aggregated topology and traffic flow measurement information upstream, the aggregated topology and traffic flow measurement information is encapsulated into a resource utilization report.

In accordance with a further aspect of the invention, a multicast-enabled router is provided. The multicast-enabled router includes a multicast topology discovery module, a messaging module, and a multicast traffic accounting manager module. The multicast topology discovery module interfaces with processes implementing an underlying multicast transport protocol to obtain topology information regarding multicast tree changes in respect of a tracked multicast flow. The messaging module conveys messages tracking resource utilization in respect of the multicast flow. And, the multicast traffic accounting manager module employs the messaging module to request resource utilization updates from dependent sub-tree portions of the multicast tree. The multicast traffic accounting manager further correlates the topology information with traffic flow measurements provided thereto via resource utilization reports.

In accordance with a further aspect of the invention, the multicast-enabled router is associated with a local access link conveying content to a destination broadcast content consumer node. The multicast-enabled router further includes a flow measurement module employed in obtaining traffic flow measurements in respect of multicast flow content conveyed to the destination broadcast content consumer node.

In accordance with a further aspect of the invention, in obtaining traffic flow measurements, the flow measurement module further employs a flow measurement means from any of: Real Time Flow Meter (RTFM), Internet Protocol Flow Information export (IPFIX), Packet Sampling (PSAMP) and Internet Protocol Performance Measurement (IPPM).

In accordance with a further aspect of the invention, the multicast-enabled router is associated with a local access link receiving content from a source broadcast content provider node. The multicast traffic accounting manager module employs the messaging module to provide correlated resource utilization reports regarding the multicast tree to a management function.

In accordance with a further aspect of the invention, the router further includes a database storing time stamped resource utilization information such as: topology information regarding dependent sub-tree portions, flow measurements regarding dependent sub-tree portions, and correlations therebetween.

In accordance with yet another aspect of the invention, the triggering event includes one of: a multicast channel join request, a multicast channel leave announcement, an announcement of an availability of a periodic traffic measurement, a resource utilization update request, a periodic resource utilization update request, an announcement regarding a multicast tree topology change, a counter rollover, and a change in content characteristics.

Advantages are derived in part from:
providing event driven communications network resource utilization reporting on a per multicast flow basis including correlated multicast topology information with leaf traffic measurements, the event driven reporting reducing reporting overheads associated wherewith;
providing decentralized resource utilization report processing eliminating the need for a centralized entity processing resource utilization reports issued by each multicast-enabled router in a communications network;
the event driven reporting and decentralized resource utilization report processing leading to scalable multicast flow accounting solutions;
a multicast transport protocol independent implementation;
customizing the resource utilization information reported provides flexibility in employing a billing model in respect of each individual multicast flow;
propagating topology information upstream to an ingress router provides support for admission control in policing the number of destination network nodes consuming broadcast content; and
propagating topology information upstream to the ingress router provides support for multicast traffic engineering.

### BRIEF DESCRIPTION OF THE DRAWINGS

The features and advantages of the invention will become more apparent from the following detailed description of the exemplary embodiments with reference to the attached diagrams wherein:

FIG. 1 is a schematic diagram showing interconnected communications network elements provisioning a broadcast service;

FIG. 2 is a schematic diagram showing, in accordance with the exemplary embodiment of the invention, interconnected communications network elements implementing a generic multicast tree branch point;

FIG. 3 is a schematic diagram showing, in accordance with the exemplary embodiment of the invention, interconnected communications network elements provisioning multicast content transport in respect of an ingress router;

FIG. 4 is a schematic diagram showing, in accordance with the exemplary embodiment of the invention, interconnected communications network elements provisioning multicast content transport in respect of an egress router; and

FIG. 5 is a schematic diagram showing functional blocks of a multicast-enabled router in accordance with the exemplary embodiment of the invention.

It will be noted that in the attached diagrams like features bear similar labels.

### DETAILED DESCRIPTION OF THE EMBODIMENTS

Although the exemplary embodiment of the invention will be presented herein with reference to one-to-many broadcast service provisioning, it is understood that the invention can also be applied, with due changes in implementation, to many-to-many broadcast service provisioning.

Methods of multicast flow accounting are sought wherein multicast traffic measurements are correlated with multicast tree topology information in respect of each monitored multicast flow in a managed domain.

Content transport protocols enabling multicast content distribution are implemented on multicast-enabled routers participating in a communications network. Such a content transport protocol includes, while not limiting the invention to, the Protocol Independent Multicast—Sparse Mode (PIM-SM) initiative by Fenner, B., Handley, M., Holbrook, H. and I. Kouvelas, which is work in progress, with an overview published by the Internet Engineering Task Force (IETF) under Request For Comments (RFC) 3569 and incorporated herein by reference.

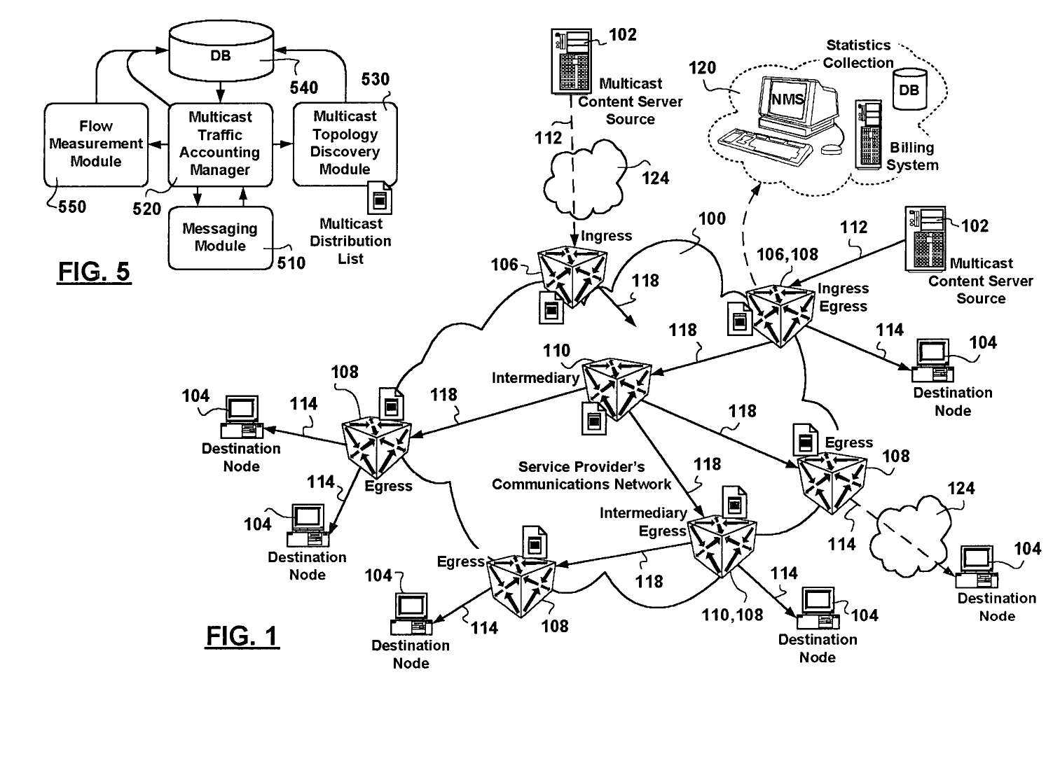

Making reference to FIG. 1, when the managed domain is a managed communications network 100, a customer broadcast content provider source node 102 and customer broadcast content consumer/user destination nodes 104 are considered to lie outside the managed communications network 100, wherein a managed multicast-enabled ingress router 106 is associated with the broadcast content provider node 102 and typically multiple managed multicast-enabled egress routers 108 are associated with multiple broadcast content consumer user nodes 104. Customer destination user nodes 104 are typically connected to edge communications network nodes including multicast-enabled egress router entities 108 either directly via an access link 114 or indirectly via an intermediary communications network 124. In the managed communications network 100, intermediate multicast-enabled routers 110 also participate in broadcast service provisioning, conveying broadcast content between the ingress router 106 and the egress routers 108.

PIM-SM may exemplary be employed by the multicast-enabled routers 106/108/110 in the communications network 100 to determine optimized multicast content distribution paths for a multicast flow within the communications network 100:

A multicast channel is defined by the tuple (S,G), where S is the address of an ingress multicast-enabled router 106 (at the edge) of the communications network 100, and G is a network address (identifier) belonging to a reserved network address space for multicast channel specification. A multicast channel is ascribed to each broadcast service potentially provisioned in the communications network 100.

When a multicast-enabled “child node”, such as a destination node 104, an egress router 108 associated with a destination node 104 or an intermediate router 110, wants to join a multicast channel, the child entity 108/110 issues a “join request” towards the ingress router 106 (S) to join the multicast channel. Typically, the join request may directed to a “parent router”. The particular parent router replying to the join request is one unicast hop from the child router 108/110 which issued the join request towards the ingress router (S) 106: the first intermediate router 110 in the shortest path towards the ingress router (S) 106, or the ingress router (S) 106 itself. If the parent router 106/110 already participates in the multicast channel, the parent router 106/110 adds an interface identifier of an interface via which the child router 110/108 may be reached (typically the interface via which the join request was received), to a local multicast distribution list maintained by the parent router 106/110; otherwise, the intermediate parent router 110 forwards (broadcasts) the join request along. The join request forwarding process is recursive until an intermediate router 110 participating in the multicast channel is reached, or the ingress router (S) 106 itself is reached. A confirmation of registration with the multicast channel is sent downstream by an upstream parent router 106/110 performing the first registration with the multicast channel. The confirmation recursively causes each child router 110 in the path to the egress router 108, including the egress router 108, to join the multicast channel.

The first destination content consumer node 104 to register with the multicast channel establishes a branchless multicast tree. Subsequent join requests for participation in the multicast channel from additional destination content consumer nodes 104 result in broadcasted join request messages being picked up by intermediary routers 10 already in the multicast tree. Underlying multicast protocol processes therefore cause the establishment of a multicast tree branch grafted to an intermediary router 10 already participating in the multicast channel. Should an intermediary router 110, or communications network infrastructure actively provisioning multicast content transport, fail, the remaining multicast-enabled routers 106/110/108 still registered with the multicast channel, re-compute the multicast tree in accordance with contingency processes of the multicast transport protocol employed.

Each multicast-enabled router 110/108/106 is aware of the multicast channel the router participates in. Each intermediary router 106/110/108, via the forwarded join requests has knowledge of all local interfaces to child routers 110/108 or destination network nodes 104. And, each multicast-enabled router 110/108, via the confirmation of registration with the multicast channel, has knowledge of its next hop parent router 106/110. Each router 106/108/110 participating in a multicast channel maintains a corresponding local distribution list, which is a list of registered interfaces to which incoming packets constituent of a corresponding multicast flow are replicated to.

Persons of ordinary skill in the art understand that the depiction of the exemplary network shown in FIG. 1 is oversimplified. In practice router entities 106/108/110 (either physical or virtual) are associated with communications network nodes having interfaces associated with physical links 118 conveying content to peer communications network nodes and interfaces associated with access links conveying content to 114, and from 112, customers; the communications network customers including: broadcast service providers 102 and broadcast content consumers 104. Therefore, in accordance with the exemplary embodiment of the invention, any particular multicast-enabled router may act concurrently as an intermediate router 110 with respect to a multicast flow, while at the same time may act as an ingress router 106 in respect of another multicast flow, and further as an egress router 108 in respect of yet another multicast flow. In respect of a particular multicast flow, an ingress router 106 may at the same time act as an egress router 108, and an egress router 108 may at the same time act as an intermediary router 110.

The paths followed by the multicast flow content transported in respect of a provisioned broadcast service form a tree made up of multicast-enabled router entities 106/110/108 at branch points in the multicast tree schematically shown in FIG. 2. Each router entity 106/110/108 branch point in the multicast tree, distributes broadcast content received from a parent entity 102/106/110 to a group of children entities, themselves router entities 110/108 or destination nodes 104, by replicating the received multicast content packets to the multiple interfaces specified in the multicast distribution list.

In accordance with an exemplary embodiment of the invention, a protocol is provided for aggregating and conveying multicast flow measurements generated by egress routers 108 upstream towards the ingress router 106. Multicast tree topology information is appended to multicast flow measurement reports as the multicast flow measurement reports are propagated upstream.

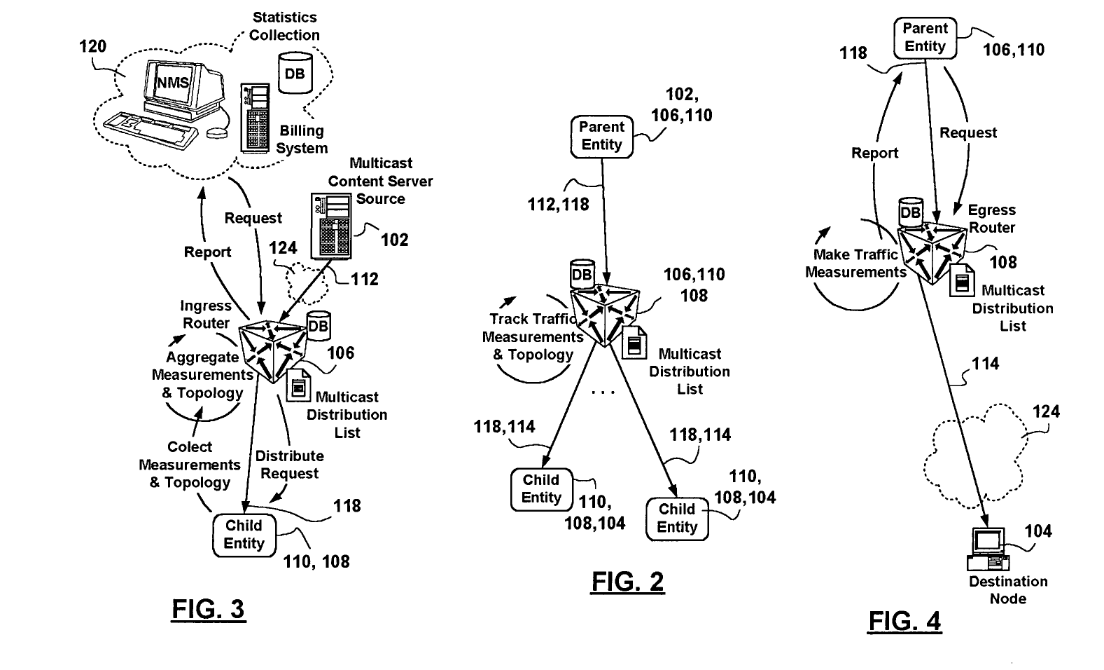

In accordance with the exemplary embodiment of the invention, each multicast-enabled router participating in a multicast group determines whether, the multicast-enabled router is an ingress router 106 in respect of a multicast flow. Making reference to FIG. 3, the multicast-enabled router, either by inspecting headers of packets conveyed therethrough in respect of the multicast flow, or via other means, determines whether its parent entity is associated with, and transmits content from, the other end of an access link 112 to the communications network 100. Included are broadcast content provider nodes 102 directly connected to an access link 112, and broadcast content provider nodes 102 connected to a remote communications network 124 accessible via an access link 112. Having determined that the parent entity 102 in respect of the multicast flow is accessible via an access link 112, the subject multicast-enabled router asserts itself as an ingress router 106 in respect of the multicast flow.

In accordance with the exemplary embodiment of the invention, as an ingress router 106 is responsible for aggregating multicast traffic measurements and associated multicast tree topology information in respect of a multicast flow, and to potentially report correlated information to higher level communication network management and provisioning functions 120 which include, but are not limited to: a network management system, statistics collector, billing platform, etc. Alternatively the ingress router 106 may store historical information regarding the multicast flow for later retrieval.

In accordance with the exemplary embodiment of the invention, each multicast-enabled router participating in a multicast group determines whether, the multicast-enabled router is an egress router 108 in respect of a multicast flow. Making reference to FIG. 4, the multicast-enabled router, either by inspecting headers of packets conveyed therethrough in respect of the multicast flow, or by other means, determines whether one of its registered interfaces in the multicast distribution list corresponding to the multicast flow, is associated with, and conveys content over, an access link 114 to a broadcast content user 104. This includes a broadcast content user nodes 104 directly connected to the access link 14, and broadcast content user nodes 104 connected to a remote communications network 124 accessible via the access link 114. Having determined that one of the child entities in respect of the multicast flow is accessible via an access link 114, the subject multicast-enabled router asserts itself as an egress router 108 in respect of the corresponding interface.

In accordance with the exemplary embodiment of the invention, as an egress router 108 in respect of the registered interface, the multicast-enabled router 108 is responsible for performing multicast traffic measurements in respect of multicast content conveyed to the broadcast content consumer node 104, and further responsible for reporting traffic measurements upstream to its parent entity.

In accordance with the exemplary embodiment of the invention, (referring back to FIG. 2) each multicast-enabled router 106/110/108 registered with a multicast channel, processes resource utilization update requests received from parent entities, and multicast tree topology information and resource utilization information received via interfaces registered in the local multicast distribution list in respect of the monitored multicast flow.

In accordance with the exemplary embodiment of the invention, each intermediary router 110 registered in a multicast group, (see FIG. 3) upon receiving a resource utilization update request in respect of the multicast flow, replicates the request to all interfaces registered in the multicast distribution list. Interfaces associated with broadcast consumer nodes 104, are handled separately as the multicast-enabled router acts as an egress router 108 therefor.

In accordance with the exemplary embodiment of the invention, each multicast-enabled router registered in a multicast group and acting as an egress router 108, in respect of an interface associated with a broadcast consumer node 104 performs traffic measurements regarding content conveyed via the interface in respect of the multicast flow and generates a resource utilization report as shown in FIG. 4.

In accordance with the exemplary embodiment of the invention, each intermediary 110 or egress 108 multicast-enabled router in possession of a resource utilization report regarding content conveyed via an interface registered with the local multicast distribution list, correlates and transmits the resource utilization report and information multicast tree topology information regarding the registered interface to the corresponding parent router 110/106.

Therefore the ingress router 106 is ultimately provided with the topology of the multicast tree along with branch specific resource utilization information. The availability of the combination of topology information and traffic measurements at the ingress router 106 enables multicast flow accounting in support of communications network management functions (120) including, but not limited to: traffic engineering, billing, etc.

In accordance with an exemplary implementation of the invention, the intermediary 10, or egress 106, router may collect resource utilization reports from all interfaces registered in the local multicast distribution list before transmitting the resource utilization information and the multicast tree topology information on to the parent router 110/106.

In accordance with the exemplary embodiment of the invention, resource utilization reports may further be prepared by egress routers 106 in full cognizance of the underlying multicast transport technology employed on an event driven basis.

Resource utilization reports are generated for example, but not limited to: as a new destination broadcast content consumer node 104 joins a multicast channel, as a destination broadcast content consumer node 104 de-registers with a corresponding multicast-enabled egress router 108 thereby leaving the multicast channel, as a multicast session completes, as a counter overflows, as the multicast-enabled routers 106/110/108 re-compute the multicast tree, as multicast flow content characteristics change (such as changes in respect of content stream compression), as other critical events occur, etc. In providing resource utilization reports, the event driven resource utilization report generation reduces reporting bandwidth overheads incurred.

In accordance with the exemplary embodiment of the invention, although a reduction in the reporting bandwidth overhead is sought, resource utilization reports generated based on, but not limited to: multicast tree topology changes and content characteristics changes (such as changes in respect of content stream compression), may be given priority in propagating thereof towards the ingress router 106, as these events directly and immediately impact resource utilization in the communications network 100.

Without limiting the invention, multicast topology and changes in respect of a multicast flow may be gleaned from messages exchanged in respect of multicast transport protocols employed and/or from infrastructure failure alarm messages.

Without limiting the invention thereto, by monitoring messages employed by the multicast transport protocol in provisioning multicast content distribution, the existence of a new multicast flow may be determined in real-time upon receiving a new multicast packet, and conversely the cessation of a multicast flow may be determined by a prolonged absence of packets being conveyed in respect of the multicast flow.

In accordance with another exemplary implementation of the exemplary embodiment of the invention, egress 108 and intermediate 110 routers may cache multicast tree topology and resource utilization report information regarding respective depending multicast tree portions, to further reduce reporting bandwidth overheads. Local storage may be used at the subject network node incurring a storage overhead. However, benefits derived from reporting bandwidth overhead reductions are weighed against having complete accurate and up to date topology and resource utilization information.

In accordance with another exemplary implementation of the exemplary embodiment of the invention, resource utilization update requests are issued periodically by the ingress node 106 in respect of a tracked multicast flow. Responding to periodic resource utilization requests enables tracking of historical multicast flow topology changes, and historical resource utilization in the communications network 100, enabling a better understanding of the network resource utilization for each multicast flow throughout its duration.

In accordance with an exemplary implementation of the exemplary embodiment of the invention, FIG. 5 shows exemplary functional blocks of a multicast-enabled router 106/110/108 employed in practicing the invention.

A messaging block 510 provides resource utilization and topology reporting functionality. Triggered by a reporting event or a received resource utilization update request, the messaging block 510 co-operates with a multicast traffic accounting manager 520 and a multicast topology discovery module 530 to obtain, encapsulate, and send resource utilization reports to a parent router 110/106 upstream along the multicast tree.

The invention is not limited to any particular messaging protocol; existing protocols, such as, but not limited to, Simple Object Access Protocol (SOAP) may easily be adapted for this purpose.

At each intermediary router 110, a topology discovery module 530 interfaces with processes implementing the multicast transport protocol to monitor local changes in the multicast tree topology. Signaling in respect of participation in multicast channel such as join requests and leave announcements are forwarded as trigger events to the multicast traffic accounting manager 520.

Each egress router 106, further employs a flow measurement module 550 to obtain traffic measurements (typically determining the number of: bytes transmitted, bytes dropped, transmitted packets, dropped packets) in respect of each interface in the multicast distribution list associated with a destination node 104. The invention is not intended to be limited to specific traffic measurement methods, exemplary methods of collecting the multicast traffic flow statistics such as, but not limited to: the Real Time Flow Meter (RTFM) an IETF standard, Internet Protocol Flow Information eXport (IPFIX) work in progress, a Netflow framework developed by Cisco Systems, Packet Sampling (PSAMP) initiative, Internet Protocol Performance Measurement (IPPM) initiative, etc. descriptions of which are published by the IETF and incorporated herein by reference.

The multicast traffic accounting manager block 520 configures the flow measurement module 550 to make resource utilization measurements on a per multicast flow basis. Resource utilization measurements may be stored in a local database 540. In accordance with the exemplary embodiment of the invention, stored resource utilization measurements are time stamped.

The multicast traffic accounting manager 520 aggregates the traffic measurements from all locally dependent branches of the multicast tree, and sends traffic measurement reports along with topology information upstream via the messaging module 510.

Via the messaging block 510, the multicast traffic accounting manager 520 communicates to child routers 110/108 requesting the topology and resource utilization updates. Received resource utilization updates and topology information regarding dependent sub-trees may be stored time stamped in the local database 540.

In accordance with an exemplary implementation of the exemplary embodiment of the invention, an exemplary data structure containing time stamped information regarding the dependent topology and multicast flow resource utilization information would have the following eXtensible Markup Language (XML) description:

```
<MulticastFlowStats>
<start_time> 2003-01-01 0:00 </start_time>
<end_time> 2003-01-01 1:23 </end_time>
<node> I2
    <node> I4
        <node> D2 </node>
    </node>
    <node> I3
        <node> D3 </node>
        <node> D4 </node>
    </node>
</node>
<stats>
    <byte_count> 200345 </byte_count>
    <packet_count> 1027 </packet_count>
</stats>
</MulticastFlowStats>
```

the <node> topology construction shown in the above example is recursive in describing the multicast tree topology, as mentioned herein above, encapsulating dependent multicast tree topology information, and the exemplary resource utilization statistics shown relate only to aggregated content transport with out limiting the invention thereto. “D” nodes represent destination broadcast content consumer nodes 104, and “I” nodes represent intermediary routers 110.

The above exemplary topology and resource utilization report provided by 12, when taken in consideration along with the following exemplary subsequent topology and resource utilization report:

```
<MulticastFlowStats>
<start_time> 2003-01-01 1:23 </start_time>
<end_time> 2003-01-01 1:25 </end_time>
<node> I2
    <node> I4
        <node> D2 </node>
    </node>
    <node> I3
        <node> D3 </node>
        <node> D4 </node>
        <node> D5 </node>
    </node>
</node>
<stats>
    <byte_count> 20035 </byte_count>
    <packet_count> 107 </packet_count>
</stats>
</MulticastFlowStats>
```

shows that a multicast tree in respect of a multicast flow was set up at 0:00, 1027 packets were transmitted, and at 1:23, the destination node D5 joined the multicast tree as a child of the intermediary router I3, and another 107 packets were transmitted.

Suppose the intermediate router I2 (110) and destination node D1 (104) are child entities of an intermediate router I1 (110). The topology and resource utilization measurements reported by I1 in respect of D1 for the duration of the multicast flow would be:

```
<MulticastFlowStats>
<start_time> 2003-01-01 0:00 </start_time>
<end_time> 2003-01-01 1:25 </end_time>
<node> D1
</node>
<stats>
    <byte_count> 220380 </byte_count>
    <packet_count> 1134 </packet_count>
</stats>
</MulticastFlowStats>
```

Then aggregate topology and resource utilization information reported by the intermediary router I1 (110) would be:

```
<MulticastFlowStats>
<start_time> 2003-01-01 0:00 </start_time>
<end_time> 2003-01-01 1:23 </end_time>
<node> I1
<node> D2 </node>
<node> I2
        <node> I4
            <node> D2 </node>
        </node>
        <node> I3
            <node> D3 </node>
            <node> D4 </node>
        </node>
</node>
</node>
<stats>
    <byte_count> 200345 </byte_count>
    <packet_count> 1027 </packet_count>
</stats>
</MulticastFlowStats>
<MulticastFlowStats>
<start_time> 2003-01-01 1:23 </start_time>
<end_time> 2003-01-01 1:25 </end_time>
<node> I1
<node> D2 </node>
<node> I2
        <node> I4
            <node> D2 </node>
        </node>
        <node> I3
            <node> D3 </node>
            <node> D4 </node>
            <node> D5 </node>
        </node>
    </node>
</node>
<stats>
    <byte_count> 20035 </byte_count>
    <packet_count> 107 </packet_count>
</stats>
</MulticastFlowStats>
```

In accordance with another exemplary implementation of the invention, resource utilization measurements may be subjected to local processing in being reported. For example, the resource utilization measurements may be weighted before storage. Weighting may be dependent on cost values ascribed exemplary ascribed to: particular access links 114 to specific destination nodes 104, particular levels of service associated with conveying content to specific destination nodes 104, type of transport protocol employed over the access link 114 in servicing the destination node 114, the type of access infrastructure deployed to the destination node, etc. As another example, an offset may be applied to resource utilization measurements before storage. Applying an offset to resource utilization measurements provides means for implementing minimum billing or flat rate billing, and/or recovering specific costs associated with delivering multicast content to a destination node 104 connected beyond the egress router 108 via another intermediary communications network 124.

Different mathematical functions (min, max, sum, etc.) may be used for the resource utilization measurement aggregation at each multicast-enabled router 106/110/108 depending on the billing strategy implemented. Processing resource utilization measurements at the egress routers 108, and at the intermediary routers 110, distributes the associated computation overhead in the communication network 100 in support of scalable multicast flow accounting solutions.

It is pointed out that it is not necessary that all communications network nodes in a vendor heterogeneous communications network 100 support the exemplary embodiment of the invention for a satisfactory operation. The more multicast-enabled routers implementing the invention participate, the more an accurate the multicast flow accounting is provided. The flexibility provides an easy migration to compliant multicast-enabled equipment.

Non-compliant multicast-enabled routers forward resource utilization update requests to all interfaces in the multicast distribution list as any other packet associated with the multicast flow. However, in accordance with the exemplary embodiment of the invention, messages reporting resource utilization and topology information may be directed specifically to the ingress router 106 (S) as opposed to the upstream parent intermediary router 110. If the parent intermediary router 110 does not implement multicast flow accounting in accordance with the invention, although the parent intermediary router 10 does participate in provisioning multicast content transport and distribution, resource utilization and topology reporting messages directed to the ingress router 106 effectively pass through the non-participating intermediary router 110. Upstream compliant intermediary 110 or the ingress 106 router intercept and interpret the resource utilization and topology reporting messages received in respect of the multicast flow from any child participating router 110/108 whether immediately connected or indirectly connected thereto.

In accordance with an exemplary implementation of the exemplary embodiment of the invention, in providing means for interoperability, if the egress router forwarding multicast content to the destination node 104 is a non-participating multicast-enabled router, an upstream parent intermediary router 110 would need to shadow the egress router in obtaining traffic measurements. Incomplete information may therefore be available from the shadowing intermediary router 110, and reported resource utilization measurements may only be available on an aggregate basis for a number of destination nodes 104.

An upstream compliant router 106/110 may determine that a child router is a non-compliant router either from errors received in respect of resource utilization update report messages forwarded thereto, and/or subsequent to the expiration of a time-out period reserved in respect of waiting for the receipt of a resource utilization report. Therefore the shadowing intermediary router 110 behaves as an intermediary router 110 for the purpose of distributing multicast traffic and as an egress router 108 for the purpose of performing multicast flow measurements.

The embodiments presented are exemplary only and persons skilled in the art would appreciate that variations to the above described embodiments may be made without departing from the spirit of the invention. The scope of the invention is solely defined by the appended claims.

1. A method of deriving resource utilization information regarding a multicast flow at a multicast-enabled router participating in a multicast tree, the method comprising steps of:
a. detecting a triggering event;
b. aggregating topology information regarding downstream dependent sub-tree portions of the multicast tree;
c. aggregating traffic flow measurements regarding content conveyed in the dependent sub-tree portions of the multicast tree downstream of the router; and
d. reporting the aggregated topology and traffic flow measurement information upstream along the multicast tree.

2. The method claimed in claim 1, further comprising a step of: correlating the topology information to the traffic flow measurement information.

3. The method claimed in claim 1, wherein detecting the triggering event comprises one of: receiving a join request, receiving a leave announcement, receiving an announcement of an availability of a periodic traffic measurement, receiving a resource utilization update request, receiving a periodic resource utilization update request, receiving an announcement regarding a multicast tree topology change, receiving an announcement regarding a counter rollover, and detecting a change content characteristics.

4. The method claimed in claim 1, wherein respect of each triggering event, the method further comprises a step of: forwarding a resource utilization update request via interfaces associated with dependent sub-tree portions.

5. The method claimed in claim 4, further comprising a step of: receiving a resource utilization report via an interface associated with a dependent sub-tree portion.

6. The method claimed in claim 5, wherein a resource utilization report in not received in respect of a resource utilization update request in respect of an interface associated with a dependent multicast tree portion, the method further comprises a step of:
a. asserting the multicast-enabled router as an egress router in respect of the interface; and
b. obtaining a traffic flow measurement in respect of content conveyed via the interface.

7. The method as claimed in claim 6, wherein obtaining a traffic flow measurement, the method further comprises a step of: associating a time stamp with the traffic flow measurement.

8. The method claimed in claim 1, further comprising a step of: storing topology information and traffic flow measurement information in storage associated with the multicast-enabled router.

9. The method claimed in claim 8, wherein storing topology information and traffic flow measurement information, the method further comprises a step of:
associating a time stamp with the stored topology information and traffic flow measurement information, enabling historical tracking of resource utilization information.

10. The method claimed in claim 1, further comprising steps of:
a. determining that multicast flow content is being forwarded via a local access link associated with a destination content consumer node;
b. asserting the multicast-enabled router as an egress router in respect of an interface corresponding to the local access link; and
c. obtaining a traffic flow measurement in respect of content conveyed via the interface.

11. The method claimed in claim 10, wherein the step of obtaining the traffic flow measurement is responsive to the triggering event.

12. The method claimed in claim 10, wherein obtaining the traffic flow measurement, the method further comprises a step of: associating a time stamp with the traffic flow measurement.

13. The method claimed in claim 10, further comprising a step of: storing traffic flow measurement information in storage associated with the egress router node.

14. The method claimed in claim 10, further comprising a step of: performing computations on traffic flow measurements providing distributed multicast flow report processing.

15. The method claimed in claim 1, further comprising steps of:
a. determining that multicast flow content is being received via a local access link associated with a source broadcast content provider node; and
b. asserting the multicast-enabled router as an ingress router in respect of an interface corresponding to the local access link.

16. The method claimed in claim 15, further comprising a step of: generating a resource utilization update request in respect of the multicast flow.

17. The method claimed in claim 15, further comprising a step of: forwarding the aggregated topology and traffic flow measurement information to a network management function.

18. The method claimed in claim 1, wherein reporting the aggregated topology and traffic flow measurement information upstream, the method further comprises a step of: encapsulating the aggregated topology and flow measurement information into a resource utilization report.

19. The method claimed in claim 18, further comprising a step of: directing the resource utilization report towards one of a next hop parent multicast-enabled router in the multicast tree, and an ingress router.

20. A multicast-enabled router providing support for multicast flow accounting, the router comprising:
a. a multicast topology discovery module interfacing with processes implementing a multicast transport protocol to obtain topology information regarding multicast tree changes in respect of a tracked multicast flow;
b. a messaging module for conveying messages tracking resource utilization in respect of the multicast flow; and
c. a multicast traffic accounting manager module employing the messaging module to request resource utilization updates from dependent sub-tree portions of the multicast tree, the multicast traffic accounting manager further correlating the topology information with traffic flow measurements provided thereto via resource utilization reports.

21. The multicast-enabled router claimed in claim 20, wherein the multicast-enabled router is associated with a local access link conveying content to a destination broadcast content consumer node, the multicast-enabled router further comprising: a flow measurement module employed in obtaining traffic flow measurements in respect of multicast flow content conveyed to the destination broadcast content consumer node.

22. The multicast-enabled router claimed in claim 21, wherein obtaining traffic flow measurements, the flow measurement module further employs a flow measurement means from any of: Real Time Flow Meter (RTFM), Internet Protocol Flow Information export (IPFIX), Packet Sampling (PSAMP) and Internet Protocol Performance Measurement (IPPM).

23. The multicast-enabled router claimed in claim 20, wherein the multicast-enabled router is associated with a local access link receiving content from a source broadcast content provider node, the multicast traffic accounting manager module further employing the messaging module to provide correlated resource utilization reports regarding the multicast tree to a management function.

24. The multicast-enabled router claimed in claim 23, the multicast traffic accounting manager module further employing the messaging module to issue a resource utilization update request subsequent to the occurrence of a triggering event.

25. The multicast-enabled router claimed in claim 24, wherein the triggering event comprises one of a: a join request, a leave announcement, an announcement of an availability of a periodic traffic measurement, a resource utilization update request, a periodic resource utilization update request, an announcement regarding a multicast tree topology change, a counter rollover, and a change content characteristics.

26. The multicast-enabled router claimed in claim 20, further comprising a database storing resource utilization information.

27. The multicast-enabled router claimed in claim 26, wherein the resource utilization information stored in the database further comprises topology information regarding dependent sub-tree portions.

28. The multicast-enabled router claimed in claim 26, wherein the resource utilization information stored in the database further comprises traffic flow measurements regarding dependent sub-tree portions.

29. The multicast-enabled router claimed in claim 26, wherein the resource utilization information stored in the database further comprises correlated topology information regarding the multicast tree and traffic flow measurements regarding dependent sub-tree portions.

30. The multicast-enabled router claimed in claim 26, wherein the resource utilization information stored in the database further comprises a time stamp.
